(19) United States
(12) Patent Application Publication
(10) Pub. No.: US 2003/0080039 A1
(43) Pub. Date: May 1, 2003

(54) Filter surface washer

(76) Inventor: Skender Cocoli, Falls Church, VA (US)

Correspondence Address: Skender Cocoli, 7754 New Providence Dr. #22, Falls Church, VA, 22042-4497, US

(21) Appl. No.: 10/039,396

(22) Filed: Oct. 26, 2001

(51) Int. Cl. B01D 24/46

(52) U.S. Cl. 210/275

(57) ABSTRACT

Disclosed herein is a filter surface washer with 8 nozzles and 4 orifices for non-air-scouring of filter medium. The filter surface washer is conceptually original device for sand and dual media rapid filters by gravity. With this type of device, the surface of the filter bed should be washed effectively for a very short period of time. The filter surface washer is very effective for 1 m² (˜11.0 ft²) of filter area. For each surface washer are required 2.5-3 l/sec/m² (3.5-4.3 gpm/ft²). The velocity of water jet in nozzle orifice should be 12-14 m/sec (39-46 ft/sec). The height of orifice of the nozzle (H₀) from top of the filter surface should be 0.1-0.142 m. The values of velocity gradient will be 1000-1500 1/sec for diameter of nozzle's orifice d₀=6 mm (¼″), and for diameter of 4 orifices d₀=0.003 m (⅛″), in lower part of the device. These values of velocity gradients should be realized when water level above the filter will be H=0.1-0.15 m, during the time of surface washing. On the upper layer of support gravel layers the velocity of water jet will be 0.25-0.275 m/sec (0.82-0.9 ft/sec) about 2-3 times lesser than permissible velocity. The time for surface washing alone is recommended 1-1.5 minutes, for concurrent wash 1-1.5 minutes, and next for backwashing alone 2-4 minute. Cleanliness of granular media will be guaranteed for a long period of time.

### BACKGROUND OF THE INVENTION

The present invention relates to drinking water purification systems, and more specifically to the surface washing of open gravity rapid filter with sand or dual media. In the practice of water treatment plants two basic backwash methods are more frequently used: 1) Up-flow water wash with surface wash, and 2) up-flow water wash with air scour.

With the first method the backwash rates should be given an expansion of filter bed of 20% to 50%. The first should be used the surface wash system for 1-1.5 minutes alone and than the concurrent wash for 1-1.5 minutes. After these two washes, the backwash alone is recommended to continue for 2-4 more minutes. Up-flow water wash with surface wash maintains a reasonable clearness of granular media for a long time. A very important part of this method of filter washing is the filter surface washer. Effectiveness to eliminate dirty filter problems and maintain a reasonable clearness of granular media for a long time depends on the filter surface washer. The device given in this invention is characterized by a high cleaning action for open gravity rapid filters with sand or dual media.

The Water Treatment Plant Design (3-rd Edition) maintains: “After the water surface level is lowered in the bed, surface wash is activated and operated alone for 1 to 3 min. Law-rate water wash is than applied simultaneously for an additional period of roughly 5 to 10 minutes. Termination of surface wash precedes a final phase (1 to 5 min) during which a higher washwater rate is used to expand bed 20% to 50% . . . Washwater flow during surface agitation is usually limited to that required to expand the bed only slightly. If anthracite makes up the top-filtering layer, bed expansion above the surface wash system may be desirable to reduce the likelihood of media loss . . . Fixed-nozzle systems typically deliver 2 to 4 gpm/ft² (5 to 10 m/h)” (p. 168).

Using the filter surface washer presented in this invention, the low rate water wash may not be used simultaneously with surface wash for 5-10 minutes. The new device is recommended for surface washing alone for 1-1.5 minutes, than concurrent wash for 1-1.5 minutes with maximum backwash, followed by backwash alone for 2-4 minutes. The total time recommended for up-flow water wash and surface wash, using the filter surface washer presented in this invention, is lower than the recommendation made in the literature mentioned above. The filter surface washer will be physically strong-produced by bronze, steel, or hard plastic material. This device is very effective and reliable with a low cost during operation and maintenance.

### BRIEF SUMMARY OF THE INVENTION

The present invention relates to the surface washing of rapid filters. The surface wash device with eight nozzles and four orifices is an optimal system, conceptually original, for efficient washing of 1 m² (10.75 ft²) of filter area. For each surface wash device is required 2.5-3 l/sec/m² (3.5-4.3 gpm/ft²). The velocity of water jet in nozzle orifice should be 12-14 m/sec (39-46 ft/sec). The height of orifice of the nozzle (H₀) from top of the filter surface should be 0.1-0.142 m. The water level above the filter should be H=0.1-0.15 m during surface washing. The value of velocity gradient is calculated by the following formula:

$$G = 1445 \cdot {d}_{{o}_{n}} \cdot {V}_{{o}_{n}} \cdot \sqrt{\frac{{V}_{{o}_{n}}}{H}} [ \text{1/sec} ] \qquad ( 1 )$$

where

G=velocity gradient, which is recommended to be 1000-1500 1/sec;

dₒ_{ₙ}=diameter of nozzle's orifice, [m]

Vₒ_{ₙ}=velocity of water jet in orifice, [m/sec]

H=water depth above the filter, [m]

The surface-washing device has eight nozzles with diameter of orifice 6 mm (¼″) and four orifices with diameter 3 mm (⅛″), in lower part of the device. On the upper layer of support gravel layers, the velocity of water jet during fluidization will be 2-3 times lower than permissible velocity. This filter surface washer is efficient for sand and dual media rapid filters.

The time for surface washing alone is recommended to be 1-1.5 minutes and for concurrent wash 1-1.5 min, and than 2-4 min backwash alone with maximum rate. Using this filter surface washer, cleanliness of granular media will be guaranteed for a long time.

### BRIEF DESCRIPTION OF THE DRAWINGS

The present invention is illustrated by the embodiments shown in the drawings, in which:

FIG. 1 is the filter surface washer with eight nozzles and four orifices (first type), a schematic representation of cross-section of FIG. 3, through A-A.

FIG. 2 is the filter surface washer with eight nozzles and four orifices (first type), a schematic representation of cross-section of FIG. 3, through C-C.

FIG. 3 is a plan, schematic representation, of cross-sections of FIG. 1 and FIG. 2, through B-B.

FIG. 4 is the filter surface washer with eight nozzles and four orifices (second type), a schematic representation of cross-section of FIG. 5, through A-A.

FIG. 5 is a plan, schematic representation (second type) of cross section of FIG. 4 through B-B.

### DETAILED DESCRIPTION OF THE INVENTION

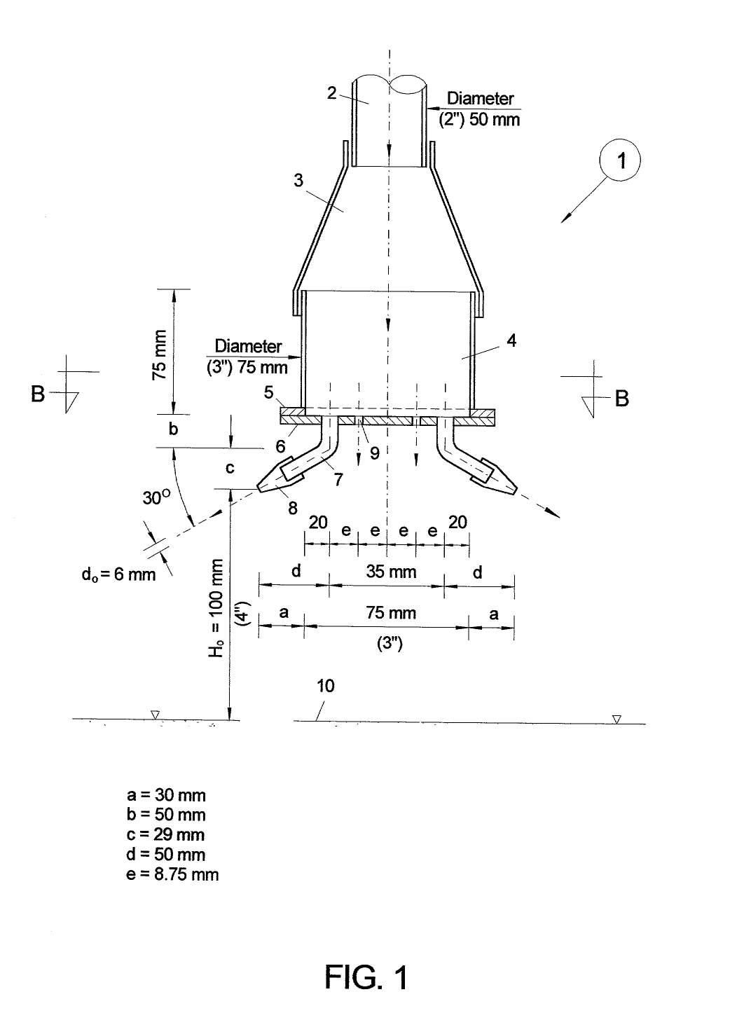

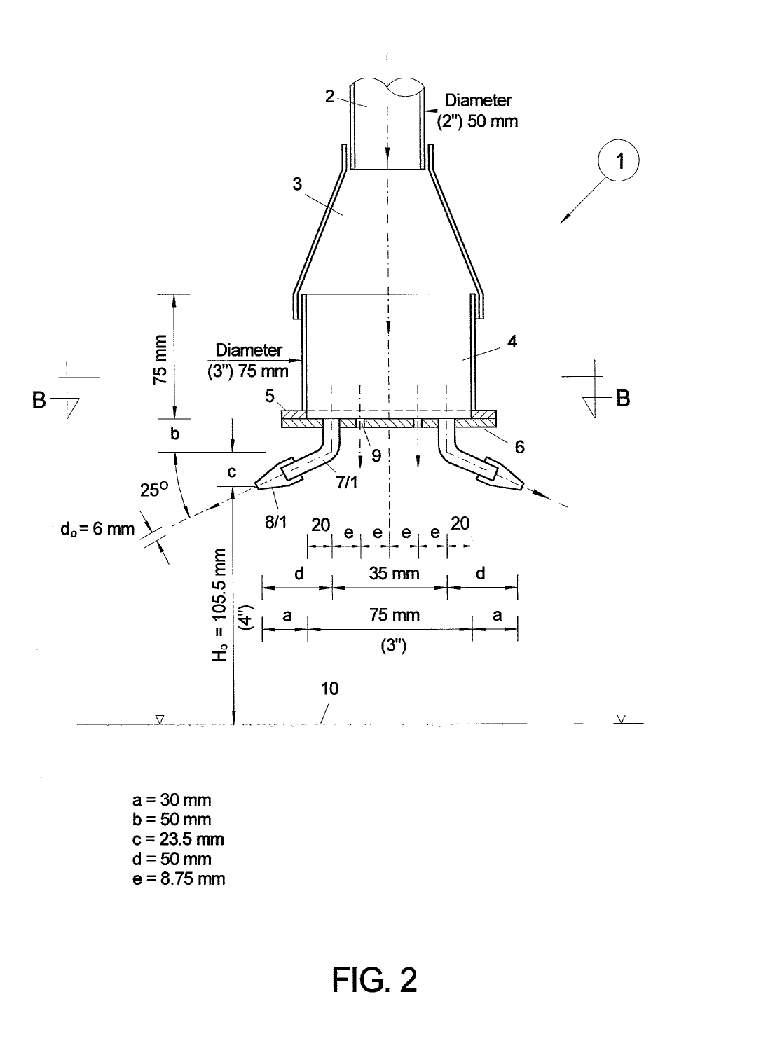

FIG. 1 shows the filter surface washer 1 with eight nozzles 8 and four orifices 9. The source of pressured water is main transmission of filtered water or pumping station. Pipe 2 is branched from pipe that supplies several filter surface washer 1, which also is branched from main transmission line or from discharge pipeline of pumping station. Pressured water supplied by pipe 2 should guarantee required head for eight nozzles 8 installed in pipe 7, with diameter ⅜″, and for four orifices 9. The eight pipes 7 and four orifices 9 are installed in flange 6. The piece of pipe 4, with diameter 75 mm (3″) fixed to flange 5, which is tied with flange 6. Pipe 2 with diameter 50 mm (2″) is connected with pipe 4, with diameter 75 mm (3″) by reducer 3 (2″/3″). The orifice of nozzles 8 with diameter 6 mm (¼″) should be 100 mm (4″) above filter surface 10. Four nozzles 8 are inclined by 30° and four nozzles 8/1 (see FIG. 2) are inclined by 25°, installed in pipe 7/1.

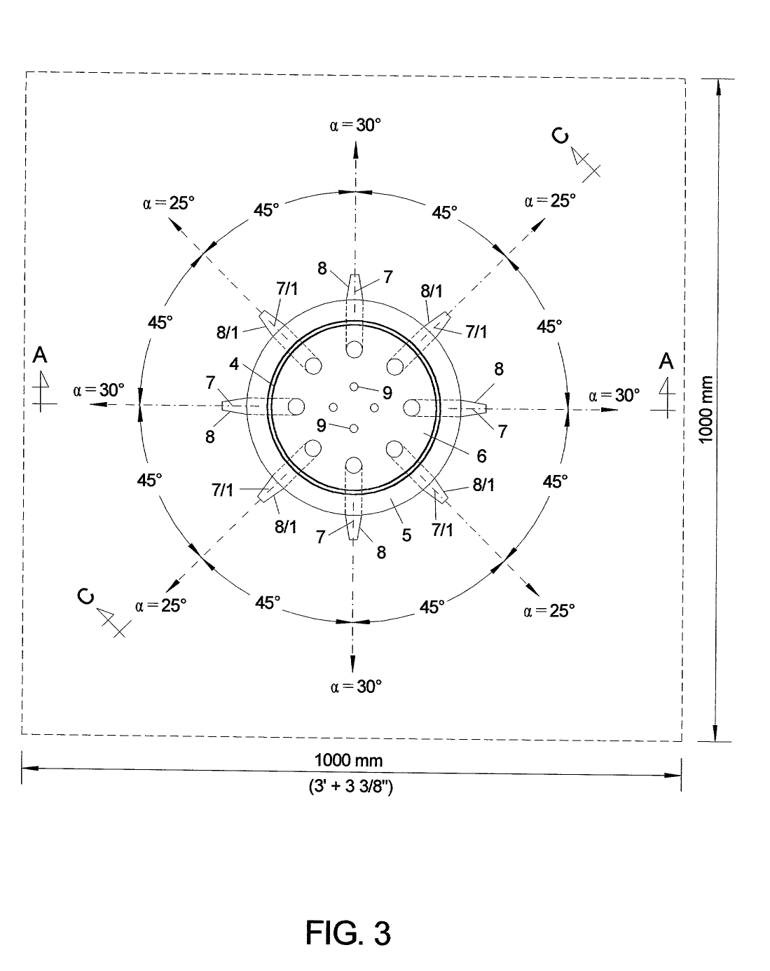

FIG. 2 shows the filter surface washer 1, as a schematic representation of cross section of FIG. 3 through C-C. The description of FIG. 2 is the same as FIG. 1.

FIG. 3 shows a plan of filter surface washer through cross-section B-B in FIG. 1 and FIG. 2. In flange 6 are installed four orifices 9, with diameter 3 mm (⅛″), four pipes 7 with nozzles 8 and four pipes 7/1 with nozzles 8/1. The diameter of orifices in nozzles 8 and nozzles 8/1 is 6 mm (¼″). Nozzles 8 installed in pipes 7 are inclined by 30° and nozzles 8/1 installed in pipes 7/1, are inclined by 25°.

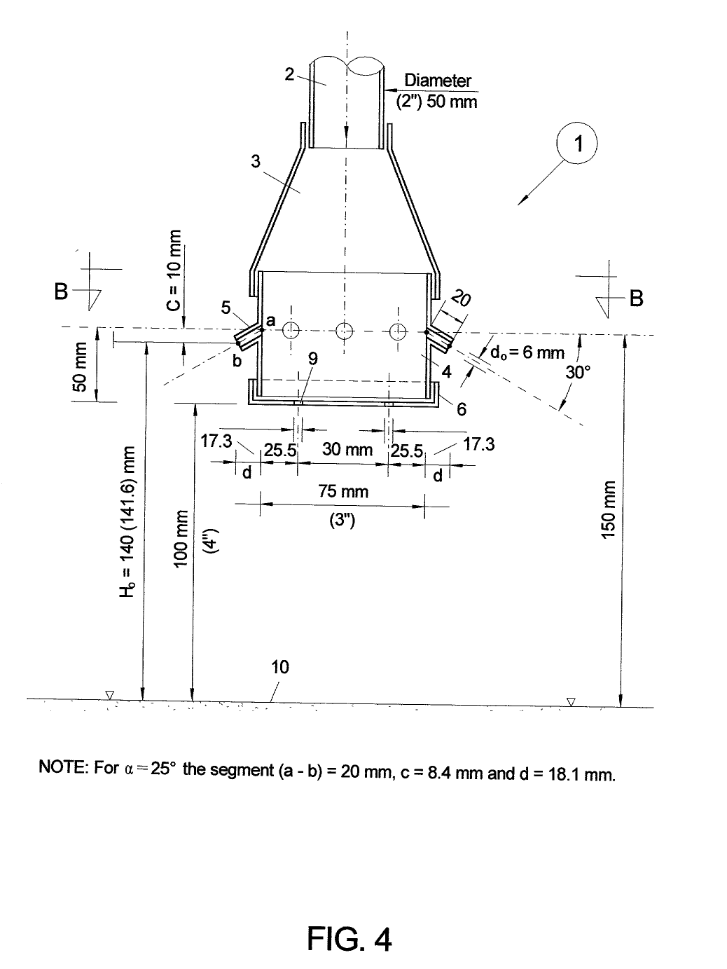

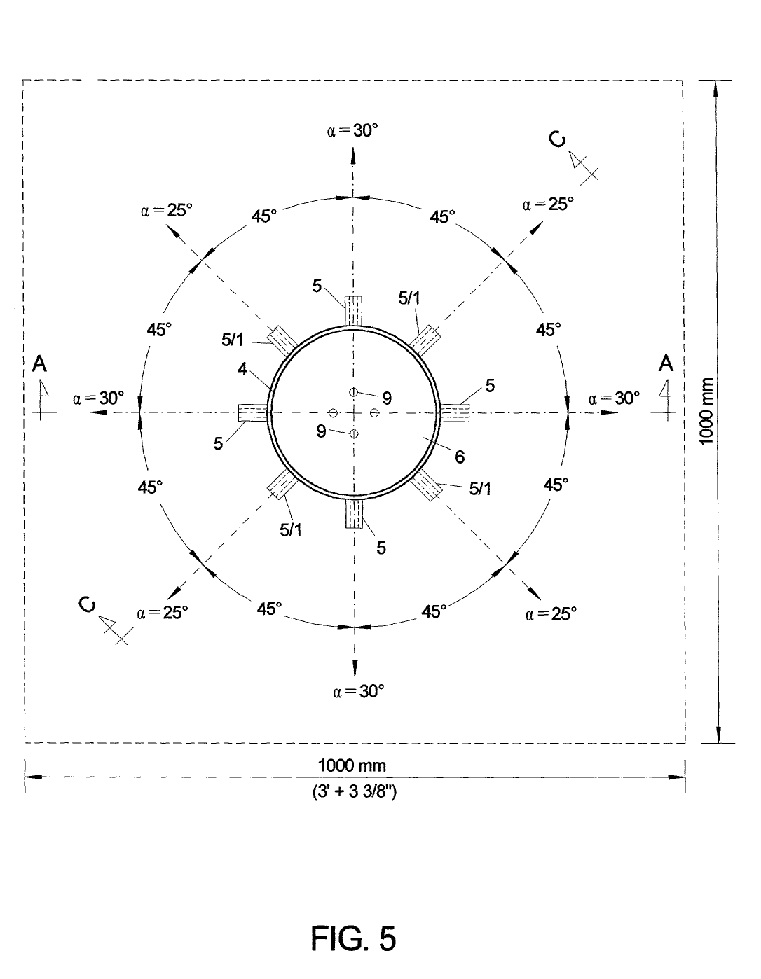

FIG. 4 shows second type of the filter surface washer 1, as a cross section of FIG. 5 through A-A and C-C. The source of pressured water is main transmission of filtered water of treatment plant or pumping station. Pipe 2 is branched from pipe that supplies several filter surface washer 1, which also is branched from main transmission line or from discharge pipeline of pumping station. Pressured water supplied by pipe 2 should guarantee required head for eight nozzles 5 and 5/1 installed in pipe 4 and four orifices installed in flange 6. Nozzles 5, as short standard tubes are inclined 30° and nozzles 5/1 are inclined 25°. The diameter of orifice in eight nozzles 5 and 5/1 is 6 mm and for four orifices 9 the diameter is 3 mm. The orifices 9 should be 100 mm (4″) above filter surface 10. The orifice of four nozzles 5 and four 5/1 should be 140 mm and 141,6 mm, respectively, above filter surface 10.

FIG. 5 shows a schematic representation of cross-section in FIG. 4 through B-B. In flange 6 are installed four orifices 9 with diameter 3 mm. In pipe 4, with diameter 75 mm (3″) are installed 4 nozzles 5 inclines by 30° and other 4 nozzles 5/1 inclined by 25°.

What I claim as my invention is:

1. A filter surface washer for self-backwashing filters, for conventional rapid sand bed and dual media filters when backwash is combined with surface wash, said:
the device comprising eight nozzles, inclined alternatively by 25° and 30°, and four orifices in the lower part of the device for jet-waters with high velocity 12-14 m/sec (39-46 ft/sec), to realize velocity gradient 1000-1500 1/sec;
the device represent an optimal solution, conceptually original, said very effective and reliable for washing 1 m² (11 ft²) of filter area, in a very short time, said without disturbing upper layer of support gravel layers and said cleanliness of granular media will be guaranteed for a long period of time.
